(19) United States
(12) Patent Application Publication
(10) Pub. No.: US 2009/0173400 A1
(43) Pub. Date: Jul. 9, 2009

(54) COMBINATION SAMPLING AND PRESSURE RELIEF VALVE

(75) Inventor: Michael Brandt, Boardman, OH (US)

Correspondence Address: HAHN LOESER & PARKS, LLP, One GOJO Plaza, Suite 300, AKRON, OH, 44311-1076, US

(73) Assignee: NATIONAL WELDING SERVICE, INC., Medina, OH (US)

(21) Appl. No.: 12/348,862

(22) Filed: Jan. 5, 2009

Related U.S. Application Data
(60) Provisional application No. 61/019,090, filed on Jan. 4, 2008.

(51) Int. Cl. F16K 17/00

(52) U.S. Cl. 137/511

(57) ABSTRACT

The present invention discloses a combination sampling and pressure relief valve. In particular embodiments, the valve includes a main body having a central bore therethrough, the central bore having first and second chamfered surfaces; a front surface having an aperture in communication with the central bore; and a rear surface having an aperture in communication with the central bore; a valve seat/stem assembly located within the central bore, the valve seat/stem assembly having first and second chamfered surfaces that are complementary to the main bore chamfered surfaces; a spring extending between the valve seat/stem assembly and a rear end cap of the valve; and, a drain aperture extending perpendicularly from the central bore to ambient, the drain aperture located between the central bore first and second chamfered surfaces. Other embodiments of the valve are disclosed.

This application claims priority to, and the benefit of, U.S. provisional patent application Ser. No. 61/019,090, filed Jan. 4, 2008, which is hereby incorporated by reference.

### TECHNICAL FIELD

The present invention relates generally to valves, and more specifically to a combination sampling and pressure-relief valve used in batch processes.

### BACKGROUND OF THE INVENTION

Different types of sampling valves are known in the art for taking samples of liquids or powders in vessels, tanks, or pipes. Furthermore, different types of pressure-relief valves are known in the art that automatically open when pressure inside of a vessel reaches a threshold level.

However, there is a need for a combination sample and pressure-relief valve that overcomes one or more of the shortcomings of the prior art. Accordingly, embodiments of the present invention are presented.

### SUMMARY OF THE INVENTION

Particular embodiments of the invention include a combination sampling and pressure relief valve and related methods. In particular embodiments, the combination sampling and pressure relief valve includes a main body having a central bore therethrough, the central bore having first and second chamfered surfaces; a front surface having an aperture in communication with the central bore; and a rear surface having an aperture in communication with the central bore; a valve seat/stem assembly located within the central bore, the valve seat/stem assembly having first and second chamfered surfaces that are complementary to the main bore chamfered surfaces; a spring extending between the valve seat/stem assembly and a rear end cap of the valve; and, a drain aperture extending perpendicularly from the central bore to ambient, the drain aperture located between the central bore first and second chamfered surfaces.

Particular embodiments of the invention may also include a spring-loaded sample and pressure relief valve including a main body having a central bore therethrough, a front surface having an aperture in communication with the central bore, and a rear surface having an aperture in communication with the central bore; a drain aperture extending from the central bore to ambient; a valve seat located within the central bore, at least a portion of the valve seat having a complementary shape to a portion of the central bore; a spring urging the valve seat against the aperture in the front surface of the main body; and, a handle for manually actuating the valve seat away from the aperture in the front surface of the main body; wherein, continuous force on the handle is required to keep the valve seat away from the aperture in the front surface of the main body.

Particular embodiments of the invention may also include a combination sample and pressure relief valve including a main body having a central bore therethrough and a valve seat/stem assembly within the main bore, the valve seat/stem assembly comprising a valve seat attached to a valve stem by a detent locking means.

The foregoing and other objects, features, and advantages of the invention will be apparent from the following more detailed descriptions of particular embodiments of the invention, as illustrated in the accompanying drawings wherein like reference numbers represent like parts of the invention.

### BRIEF SUMMARY OF THE DRAWINGS

FIG. 1 is a bottom view of an embodiment of a spring-loaded sample/relief valve.

FIG. 2 is a top plan view of the valve of FIG. 1

FIG. 3 is an exploded view of the valve of FIG. 1.

FIG. 4 is a bottom view of valve main body with valve stem inserted within valve body.

FIG. 5 is a bottom view of valve main body with valve stem and spring inserted within valve body.

FIG. 6 is a bottom view of valve main body with valve stem and spring inserted within valve body, and rear valve cap attached to valve body.

FIG. 7 is a rear end view of valve main body.

FIG. 8 is a front end view of the valve main body of FIG. 7.

FIG. 9 is a front end view of valve rear end cap.

FIG. 10 is a rear end view of the valve rear end cap of FIG. 9.

FIG. 11 is a cross-sectional view of the valve of FIG. 1.

FIG. 12 is a top plan view of a valve stem without a valve member attached.

FIG. 13 is a cross-sectional view of a valve member with o-ring that is attached to the front of the valve stem.

FIG. 14 is a cross-sectional view of a valve main body.

FIG. 15 is an end view of a rocker handle.

FIG. 16 is a side view of the rocker handle of FIG. 15.

### DETAILED DESCRIPTION OF PARTICULAR EMBODIMENTS

An embodiment of a combination sample/relief valve (also referred to as the “valve”), which is generally identified by reference numeral 10, is illustrated in the Figures. Valve 10 may comprise main body 20, valve seat/stem assembly 50, spring 62, washer 64, rear end cap 70, and handle 80.

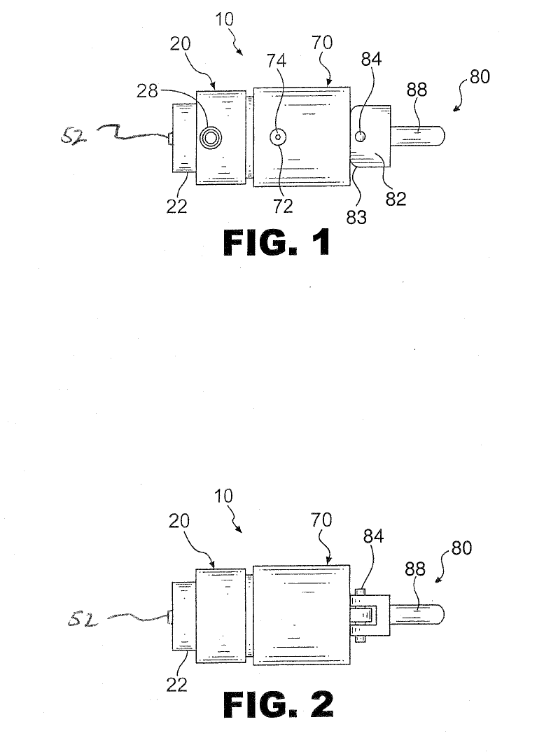

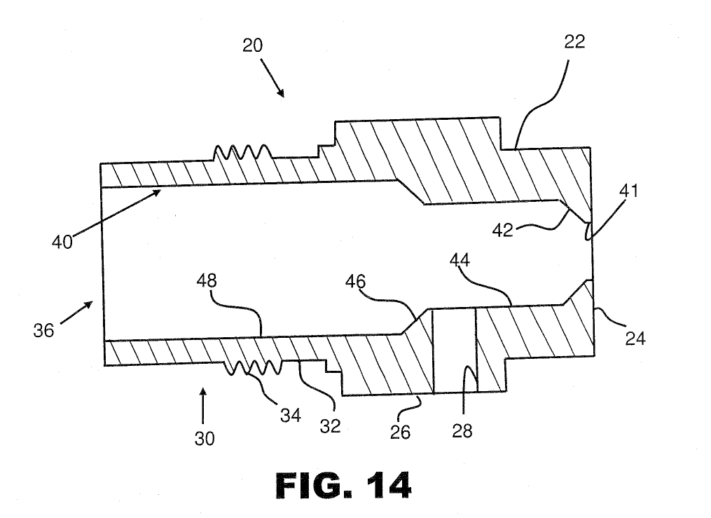

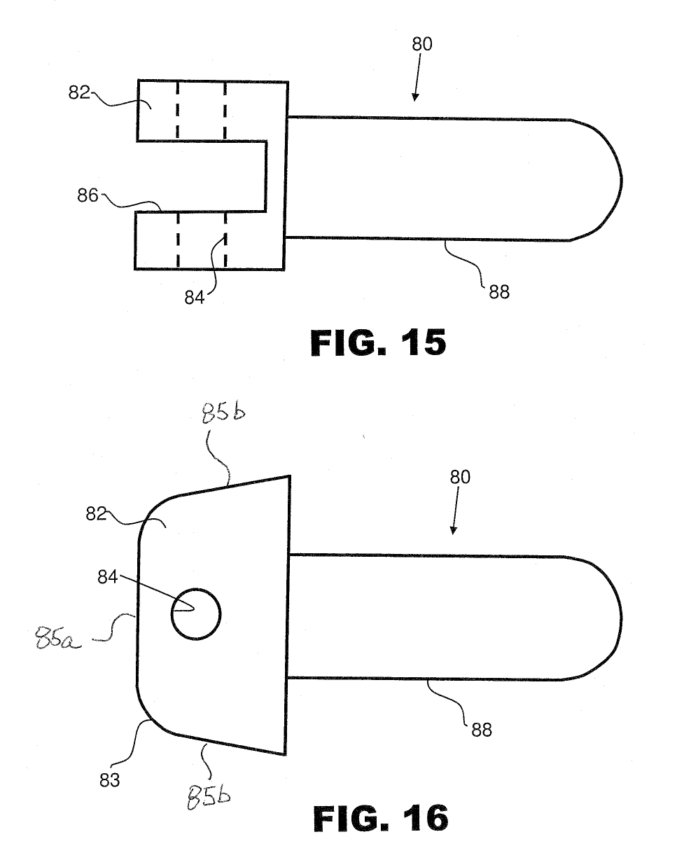

As illustrated in FIGS. 1-6 and 14, main body 20 may comprise a first front portion 22, middle portion 26, and rear portion 30 having a plurality of threads 34 and a non-threaded portion 32. As illustrated in FIG. 14, the main body 20 may additionally comprise a main bore 40 therethrough that extends rearwardly from front opening 41 and includes front chamfered surface 42, front bore portion 44, rear chamfered surface 46, and rear bore portion 48. As illustrated, front opening 41 may have a smaller cross-sectional diameter than front bore portion 44, which may have a smaller diameter than rear bore portion 48.

Front portion 22 may adapted to be inserted within an opening in a tank, pipe, or other structure that may be pressurized from time to time. Front portion 22 may also include front face 24 that directly contacts or engages the interior contents of the tank, pipe, or other structure. Front portion 22 may extend rearwardly a predetermined or preselected distance and may terminate at a shoulder (not numbered) that defines the front surface of middle portion 26. Middle portion 26 is adapted to be located externally relative to the tank, pipe or other structure, and may include an aperture 28 that extends from front bore portion 44 to the external surface of middle portion 26. Aperture 28 may be attached to a drain hose, line, or tube of a predetermined length by friction fitting, welding, a threaded connection, or any other known means. Aperture 28 may also drain valve 10 when valve is closed, such as when a gap remains between front bore portion 44 and the valve seat/stem assembly 50, such as is shown by example in FIG. 11.

Rear portion 30 may extend rearwardly from middle portion 20, the transition of which may include one or more shoulders (unnumbered). Rear portion 30 may include non-threaded portion 32 and threaded portion 34 spaced rearwardly from non-threaded portion 32. Rear portion may further comprise rear surface 36 through which main bore 40 extends.

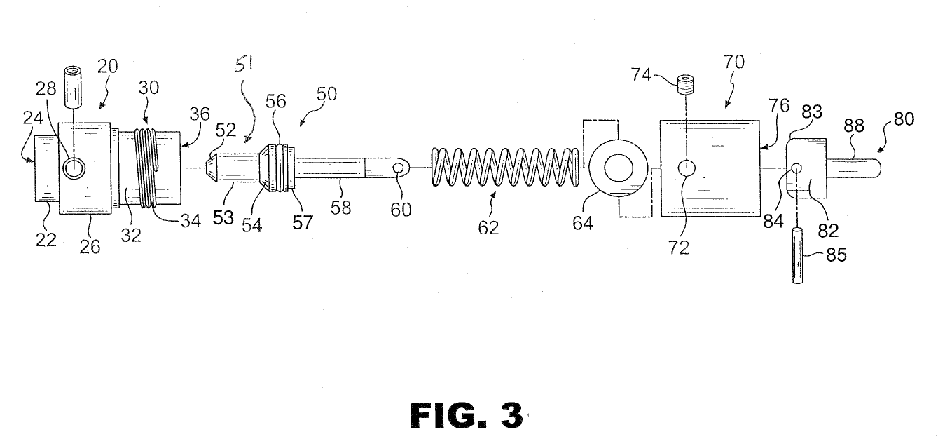

As illustrated in FIGS. 3 and 11, valve seat/stem assembly 50 is received within main bore 40 of main body 20. Valve seat/stem assembly 50 may comprise valve stem 58 having aperture 60 therethrough and a valve seat 51 attached to valve stem 58. In particular embodiments, the valve seat 51 may comprise any of a plurality of polymers, including, for example, rigid polymers. In a particular application, the valve seat 51 comprises polytetrafluoroethylene (PTFE), such as, for example, Teflon®, which is manufactured by DuPont. The use of polymers allows any particulates or matter that may become trapped along the valve seat 51 to become embedded within its surface, for the purpose of maintaining a proper seal with main bore 40 and main body 20. Otherwise, any trapped particulate may remain positioned between the valve seat 51 and bore 40 to create a gap there between, which thereby prevents proper closure of valve 10. In lieu of polymers, any other similar materials capable of receiving (i.e., embedding) a particulate may be used, such as, for example, a soft (i.e., deformable) metal or elastomer. In other embodiments, valve seat 51 may be formed of any other desired material, such as a hard metal. In any embodiment, the use of a metal to form any portion of valve seat 51 may be dissimilar to the metal used to form valve stem 58.

Valve seat 51 may further comprise an outer recess (unnumbered) that houses an o-ring 56. O-ring 56 may be manufactured from any of a plurality of resilient polymers or elastomers. In one embodiment, the o-ring 56 comprises a fluoroelastomer, such as, for example, Viton®, which is manufactured by DuPont.

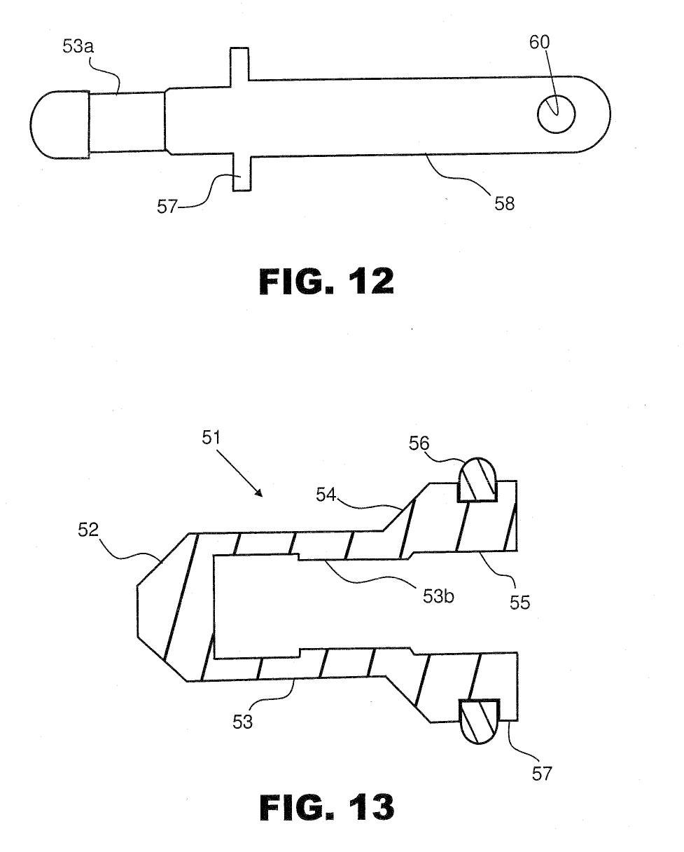

The valve seat 51 may be attached to valve stem 58 by any of a plurality of methods. In the embodiments of valve seat 51 and valve stem 58 illustrated in FIGS. 12-13, valve stem 58 may comprise a recessed portion 53a that receives corresponding projection portion 53b in the recess 55 of valve seat 51. Valve seat 51 may therefore attach to valve stem 58 by an interference or detent locking mechanism, whereby the recess 55 of valve seat 51 biases slightly as the valve seat 51 is installed on valve stem 58 until the projection 53b of valve seat 51 engages the recess 53a on valve stem 58. Therefore, once the valve seat 51 is installed on the valve stem 58, the valve seat 51 may not be removable from the valve stem 58 without damaging the valve seat 51. Damage may be facilitated by the engagement of the generally square edges associated with the front side of valve stem recess 53a and the front side of valve seat projection 53b. This feature makes the valve seat tamper-evident, as attempts to alter the valve seat 51-valve stem 58 connection will cause damage to the connection. Attachment of valve stem 58 and valve seat 51 may be achieved by other means to also provide a tamper-evident assembly. In other embodiments, valve stem 58 and valve seat 51 may be permanently attached, or formed monolithically as a single member.

In one embodiment, the recess 53a on valve stem 58 may be slightly longer than the projection 53b on valve seat 51, which allows the valve seat 51 to move slightly longitudinally relative to valve stem 58 and/or rotate slightly relative to valve stem 58. This feature allows the valve handle 80 to move slightly without actuating the valve 10, as further described below. Further, this allows valve seat 51 to rotate due to the turbulence created by the in flux of fluid through aperture 41. The rotation allows the valve seat 51 to be cleaned, whereby particulates and other matter may be removed from any sealing surfaces, such as, for example, surfaces 52 and 54.

In particular embodiments, when valve seat/stem assembly 50 is fully inserted within main body 20 in the closed position, the front chamfered surface 52 is complementary to front opening 41 and/or front chamfered surface 42 of main body 20, and rear chamfered surface 54 of valve seat 51 is complementary to rear chamfered surface 46 of main body 20, such as is shown by example in FIG. 11. Accordingly, the engagement of each pairs of surfaces 52-42 and 54-56 form a double seal between valve seat 51 and main body 20. In particular applications, a single seal may instead be provided by one of the pair of surfaces. Chamfered surfaces 52, 54, 42, and 46 may extend at any angle relative to the longitudinal extension of valve 10. In particular arrangements, surfaces 52, 54, 42, and 46 extend at an angle between 30 and 48 degrees relative to the longitudinal extension of valve 10. In other applications, cylindrical portion 53 of valve seat 51 is complementary to front bore portion 44 of main body 20, and/or rear portion 57 of valve seat 51 with o-ring 56 is complementary to rear bore portion 48 of main body 20.

As illustrated in by example in FIGS. 1, 2, 4-6, and 11, the front surface or tip 52 of valve seat 51 may protrude through aperture 41 when the valve seat 51 is biased in the closed position. In this manner, very little to no product (including particulates or other matter) in the attached tank, pipe, or structure can enter any part of the valve 10.

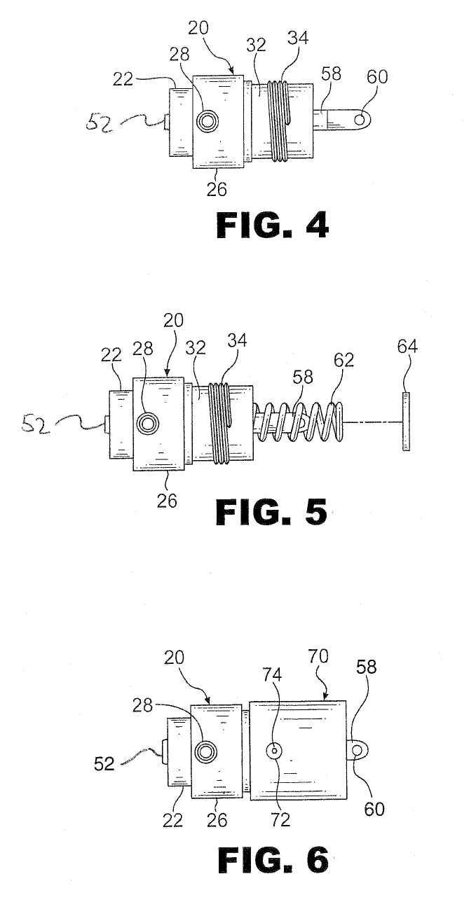

As is illustrated in the Figures, valve stem 58 may be of smaller diameter than rear bore portion 48 of main body 20. As illustrated in FIGS. 3 and 5, spring 62 is positioned about valve stem 58 and partially located within rear bore portion 48 of main body 20. A front portion of spring 62 may abut rear portion 57 of valve seat 51. As shown in FIG. 6, rear end cap 70 may be mechanically attached to main body 20.

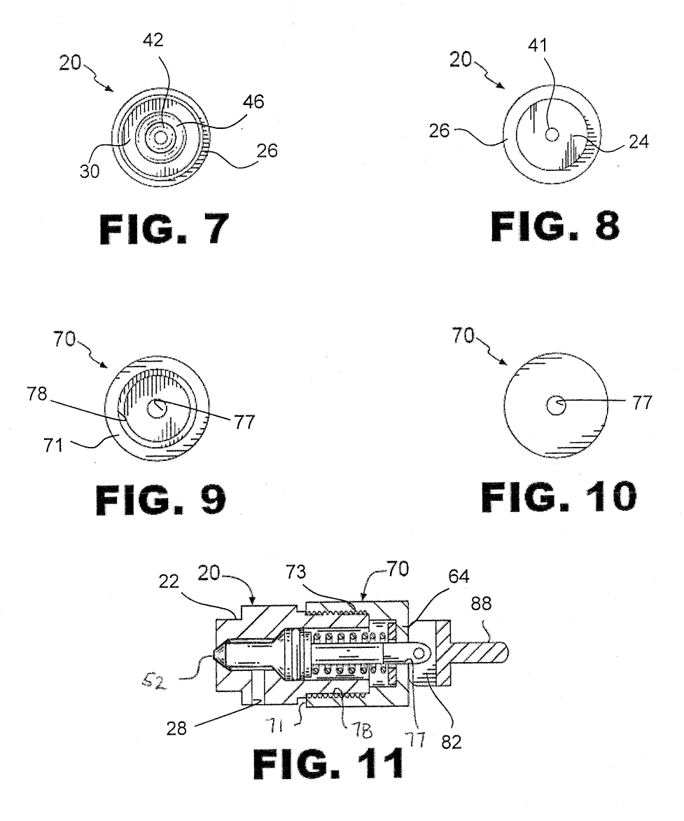

With specific reference to FIGS. 3, and 7-11, rear end cap 70 may comprise a generally cylindrical main body having a bore 78 therethrough that extends rearwardly from a front end 71 of the rear end cap 70. The bore 78 may be at least partially threaded 73. The bore 78 of rear end cap 70 may be complementary to rear portion 30 of main body 20 and may be of a size sufficient to attach rear end cap 70 to main body 20. In the embodiment illustrated in the Figures, end cap 70 is attached to main body 20 via threads 34 located on the exterior surface of main body that engage threads 73 located on an interior surface of end cap 70. FIG. 6 illustrates rear end cap 70 installed on main body 20. As illustrated, the rearwardmost portion of valve stem 58 may extend through rear aperture 77 of rear end cap 70 when the rear end cap 70 is fully installed on main body 20. It should be appreciated that as the user installs rear end cap 70 on main body 20, some force may be required to compress spring 62. Spring 62 may comprise any force spring as desired. For example, in particular applications, spring 62 may be a 75 pound spring, or a 100 pound spring.

As illustrated in FIGS. 3 and 11, a washer 64 may be positioned within rear end cap 70 such that it contacts the spring 62 end. The washer 64 may be any of a plurality of materials such as, for example, polymers and plastics. In one embodiment, washer 64 comprises PTFE. Washer 64 may help reduce galling or wear between the spring 62 and rear end cap 70.

End cap 70 may further comprise threaded aperture 72 that receives a set screw 74. When the end cap 70 is fully installed on main body 20, threaded aperture 72 and set screw 74 overlays portion 32 of rear portion 30 of main body 20. By tightening the set screw to be in contact with portion 32 after the rear end cap 70 is fully installed, rear end cap 70 may be precluded from being removed form main body 20. In other words, while the end cap 70 may be rotatable a short distance, the end cap 70 is prevented from full removal because set screw 74 does not clear threads 34. Only by loosening set screw 74 can the rear end cap 70 be unscrewed from main body 20. This optional feature increases the safety of valve 10 because the valve 10 cannot be simply unscrewed—a tool is required. It is contemplated that other means known to one of ordinary skill in the art may be used to prevent unintentional removal of end cap 70 from main body 20.

As illustrated in FIGS. 1, 2, 3, and 11, a rocker handle 80 may be attached to the portion of valve stem 58 that extends through rear end cap 70. Rocker handle 80 may comprise a base portion 82 that has rounded ends 83. The base 82 may include a slot 86 that receives the valve stem 58. Aperture 84 may extend through base 82 such that it intersects slot 86. Handle portion 88 may extend from base 82. Handle portion may comprise any desired cross-sectional shape and size. In the embodiment illustrated in the Figures, handle portion 88 is round or cylindrical. Rocker handle 80 may be formed from discrete pieces or may be integrally or monolithically formed as a single unit.

To attach rocker handle 80 to valve stem 58, valve stem 58 is positioned within slot 86 in rocker handle base 82 such that the aperture 60 in valve stem 58 is aligned with the aperture 84 in rocker handle base 82. A pin 85 may then be inserted through both apertures 60, 84 to secure the rocker handle 80 to valve stem 58. As can be appreciated, valve seat/stem assembly 50 can be installed within main body 20 in any orientation based upon the preferences of the user. The orientation of valve seat/stem assembly 50 determines the orientation of rocker handle 80 relative to main body 20, and particularly drain aperture 28.

As can be appreciated from the drawings, when the valve 10 is fully assembled, spring 62 is under compression, which biases valve seat/stem assembly 50 against aperture 41 and/or front chamfered surface 42 of main body 20, to prevent any passage of product or material through aperture 41 and to provide a closed valve 10. The valve can either be opened manually by actuating rocker handle 80 or automatically by force being applied to valve seat 51. In a pressure relief scenario, an amount of pressure exerted from within the attached tank or pipe will overcome the force imposed by spring 62 on valve seat 51 and will translate valve seat 51 at least slightly away from aperture 41 in main body. Fluid from the tank or pipe may then weep or flow through aperture 41 and into front bore portion 44 of main body 20, and out drain aperture 28. After the pressure inside tank or pipe has reduced sufficiently, the force of spring 62 will cause the valve seat 51 to re-seat within bore 40 in main body 20, thereby closing valve 10.

The front surface 52 of valve seat 51 may be rounded, conical, or frustoconical, as illustrated in the Figures. With such a shape, as the valve opens and pressurized fluid flows from the tank or pipe into the valve 10, the fluid will be dispersed around front surface 52, which causes turbulence in the fluid flow. The turbulent fluid flow helps to clean the valve seat 51 and particularly the front surface 52 via the shearing action from the fluid acting on the valve seat 51. The turbulent flow may also cause the seat 51 to rotate, which may further improve the cleaning action.

The spring 62 of valve 10 can be selected based upon the normal pressure range existing inside the attached tank or pipe. For example, if normal pressure inside a tank or pipe reaches 70 psi, the spring 62 can be selected such that greater than 70 psi is required inside the tank or pipe to open the valve 10. In one embodiment, 105 psi is required to open the valve, but any psi is contemplated, such as pressures ranging from 25-300 psi. In this embodiment, the spring 62 is approximately 0.42 inches wide and 1.5 inches long, with a wire thickness of 0.055 inches. It should be appreciated that embodiment of a spring 62 is exemplary only, and that one skilled in the art can select a spring 62 of different widths, lengths, and wire thicknesses to achieve the desired psi required to open the valve.

To manually open the valve 10, rocker handle 80 may be rotated or pivoted about the axis formed by pin 85, apertures 84, and/or aperture 60. As can be appreciated from the Figures, the distance from aperture 84 to the bottom of base portion 82 is shorter than the distance from aperture 84 to the sides of base 82. Therefore, as manual force is applied to rotate rocker handle 80 for example, ninety degrees, the aperture 84 and thus the valve stem 58 will overcome the spring force exerted on it will translate away from main body 20. In the process, and the valve seat 51 will translate away from opening 41 in main body 20 and valve 10 will open.

Rocker handle 80 may function as a deadman handle or switch, which requires a user to maintain the handle 80 in a valve-open position to otherwise prevent the valve from automatically closing, an exemplary configuration of which is described hereafter. The base 82 of rocker handle 80 may have rounded corners 83, as illustrated in FIGS. 3 and 16. In particular applications, base 82 may include one or more sides 85b (also referred to as “angled sides”) that extend outwardly while extending from corners 83 and bottom or front side 85a, such that the top or rear side of base 82 is wider than bottom or front side surface 85a, such as is shown by example in FIG. 16. It can also be said that any such angled side 85b extends outwardly and rearwardly relative to the valve. As rocker handle 80 is rotated up to ninety degrees to the open position, the spring 62 is compressed, which creates the potential for urging the valve seat 51 shut or closed. When the user releases rocker handle 80, a rounded corner 83 (and any angled side 55b, if present) allows the compressed spring 62 to automatically forcefully rotate the rocker handle 80 back to a valve-closed position. Therefore, the handle or switch 80 may have the inherent safety feature that it cannot be left in an open position without force being continually applied to rocker handle 80. In an alternate embodiment, the rocker handle base 82 have have more squared off corners or acute corners such that once the valve is open, it will stay open until manually closed. Alternatively, one corner of the base 82 may have a round corner and the other corner may be a squared corner or acute corner, such that valve would stay open if the rocker handle were rotated in the direction with the rounded base corner, and would stay open if the rocker handle were rotated in the direction of the squared or acute corner.

In one embodiment, the main body 20, valve stem 58, rear end cap 70, and rocker handle 80 are formed from 316 stainless steel. In other embodiments, the components 20, 58, 70, and 80 may be formed from other stainless steels, aluminum or aluminum alloys, or any of a plurality of other metals.

To assemble valve 10 from its components, valve seat/stem assembly 50 may be first assembled by press-fitting or snap-fitting valve seat 51 onto valve stem 58. Valve seat/stem assembly 50 may then be inserted within main body 20, as illustrated in FIG. 4. It is contemplated that valve seat 51 may be configured to be snugly slideable within main bore 40 due to a relatively tight fit between cylindrical portion 53 of valve seat 51 and front bore portion 44 of main bore 40. The interaction of surfaces 52 and 42, and surfaces 54 and 46 form a double seal between valve seat 51 and main body 20 and central bore 40. O-ring 56 forms a third seal between valve seat 51 and main body 20 and central bore 40. Spring 62 may then be inserted over valve stem 58 and partially within rear bore portion 48 of main bore 40, as illustrated in FIG. 5. Rear end cap 70, with washer 64 inserted in bore 78, may then be screwed onto main body 20 until rear end cap 70 is tight. The rear portion of valve stem 58 may now extend through aperture 77 in rear end cap 70, as illustrated in FIG. 6. Rocker handle 80 may then be attached to valve stem 58 by aligning aperture 60 in valve stem 58 with aperture 84 in rocker handle 80, and inserting a fastener such as pin 85, cotter pin, or any of a plurality of other fasteners through both apertures 60, 84. Either before or after rocker handle 80 is secured to valve stem 58, but after rear end cap 70 is attached to main body 20, optional set screw 74 may be screwed into aperture 72 in rear end cap 70 to lock the rear end cap to main body 20.

Once the valve 10 is assembled, it may be attached to a tank, pipe, or other desired structure. The front portion 22 of main body 20 may be inserted within an aperture in the tank that is at least slightly larger than the diameter of front portion 22 but smaller than the diameter of middle portion 26. The valve 10 can then be attached to the opening via welding or any of a plurality of other manners. For example, front portion 22 of main body 20 may be threaded and the valve 10 may be threadingly attached to an aperture in the tank, pipe, or other structure, or front portion 22 may be attached to tank or pipe by an adhesive.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

What is claimed is:

1. A combination sampling and pressure relief valve, comprising:
a main body having a central bore therethrough, the central bore having first and second chamfered surfaces; a front surface having an aperture in communication with the central bore; and a rear surface having an aperture in communication with the central bore;
a valve seat/stem assembly located within the central bore, the valve seat/stem assembly having first and second chamfered surfaces that are complementary to the main bore chamfered surfaces;
a spring extending between the valve seat/stem assembly and a rear end cap of the valve; and,
a drain aperture extending perpendicularly from the central bore to ambient, the drain aperture located between the central bore first and second chamfered surfaces.

2. The valve of claim 1, wherein a rear portion of the main body comprises a plurality of external threads.

3. The valve of claim 2, wherein the rear end cap includes a bore therethrough that at least partially includes interior threads, the rear end cap being threadedly attached to the rear portion of main body.

4. The valve of claim 3, wherein the valve seat/stem assembly extends through the rear end cap bore beyond an end of the rear end cap.

5. The valve of claim 1, further comprising:
a rocker handle attached to the valve seat/stem assembly.

6. The valve of claim 5, wherein the rocker handle includes a base portion with rounded corners.

7. The valve of claim 5, wherein the rocker handle includes a base portion having one or more angled sides, each of which extend outwardly and rearwardly relative to the valve.

8. The valve of claim 5, wherein the rocker handle is pivoted to open the valve, and wherein continuous force on the rocker handle is required to keep the valve open.

9. The valve of claim 1, wherein the valve seat at least partially extends through the main body front surface aperture when the valve is closed.

10. The valve of claim 1, wherein the valve seat is comprised of polytetrafluoroethylene.

11. The valve of claim 1, further comprising an O-ring operably attached to the valve seat, the O-ring being spaced rearwardly of the valve seat chamfers and contacting a portion of the central bore.

12. The valve of claim 11, wherein the O-ring comprises Viton®.

13. The valve of claim 1, wherein a front portion of the valve seat is conical or frustoconical.

14. The valve of claim 1, wherein the main body and rear end cap comprises 316 stainless steel.

15. The valve of claim 1, wherein the valve seat is attached to the valve stem by a detent locking structure.

16. A spring-loaded sample and pressure relief valve, comprising:
a main body having a central bore therethrough, a front surface having an aperture in communication with the central bore, and a rear surface having an aperture in communication with the central bore;
a drain aperture extending from the central bore to ambient;
a valve seat located within the central bore, at least a portion of the valve seat having a complementary shape to a portion of the central bore;
a spring urging the valve seat against the aperture in the front surface of the main body; and,
a handle for manually actuating the valve seat away from the aperture in the front surface of the main body; wherein,
continuous force on the handle is required to keep the valve seat away from the aperture in the front surface of the main body.

17. The spring-loaded sample and pressure relief valve of claim 16, wherein when a threshold level of external pressure is applied to the valve seat, the valve seat actuates away from the aperture in the front surface of the main body.

18. The spring-loaded sample and pressure relief valve of claim 16, wherein a front portion of the valve seat is conical or frustoconical.

19. The spring-loaded sample and pressure relief valve of claim 16, wherein the central bore has first and second chamfered surfaces, the valve seat having corresponding first and second chamfered surfaces.

20. A combination sample and pressure relief valve, comprising:
a main body having a central bore therethrough;
a valve seat/stem assembly within the main bore, the valve seat/stem assembly comprising a valve seat attached to a valve stem by a detent locking means.
